(19) United States
(12) Patent Application Publication
(10) Pub. No.: US 2014/0241133 A1
(43) Pub. Date: Aug. 28, 2014

(54) Satellite Signal Receiving Device, Electronic Timepiece and Satellite Signal Receiving Method

(71) Applicant: Seiko Epson Corporation, Tokyo (JP)

(72) Inventor: Norimitsu Baba, Nagano-ken (JP)

(73) Assignee: Seiko Epson Corporation, Tokyo (JP)

(21) Appl. No.: 14/189,657

(22) Filed: Feb. 25, 2014

Related U.S. Application Data
(60) Provisional application No. 61/770,577, filed on Feb. 28, 2013.

(30) Foreign Application Priority Data
Feb. 26, 2013 (JP) 2013-035510

(51) Int. Cl. G04R 20/02; G04C 10/02

(52) U.S. Cl. CPC G04R 20/02; G04C 10/02
USPC 368/47; 136/252

(57) ABSTRACT

A satellite signal receiving device includes a receiving circuit that receives a satellite signal transmitted from a position information satellite, a solar cell that converts light energy into electrical energy, and a control section that controls the receiving circuit and starts a receiving process of the satellite signal, when illuminance of light incident on the solar cell is equal to or greater a preset illuminance threshold within a range of equal to or greater than 1,000 Lx and less than 5,000 Lx.

### BACKGROUND

1. Technical Field

The present invention relates to a satellite signal receiving device that receives a satellite signal transmitted from a position information satellite such as a GPS satellite, an electronic timepiece using the satellite signal receiving device, and satellite signal receiving method.

2. Related Art

Electronic devices that receive satellite signals from GPS (Global Positioning System) satellites to perform time correction and positioning are known (see, for example, JP-A-2008-39565 (Patent Document 1)).

For such electronic devices, when a device like, for example, a watch moving together with a user is assumed, it is considered that the electronic devices may move into the environments, such as the inside of a house or an underground shopping area, which are not capable of receiving satellite signals.

When a receiving process is performed in such environments in which there is no capability of receiving satellite signals, power is uselessly consumed. Particularly, in a battery-driven electronic device like a watch, it is necessary to reduce current consumption in order to secure time duration or reduce the size of a battery, and it is necessary to prevent a useless receiving process from being performed.

For this reason, Patent Document 1 discloses a technique in which focusing on a fact that the outdoor illuminance of ambient light is higher than the indoor illuminance, an electronic device is provided with a solar panel, it is determined that the electronic device is disposed outdoors when the illuminance of light incident on the solar panel is a preset illuminance threshold or greater, and a process of receiving a satellite signal is performed.

Here, in Patent Document 1, the illuminance threshold for determining that the electronic device is disposed outdoors is set to 5,000 Lx. However, with such a setting, when the sunlight is weak like, for example, on cloudy or rainy days, it is incorrectly determined that the electronic device is disposed indoors in spite of the device being disposed outdoors, and a process of receiving a satellite signal may not be performed. In this case, the frequency of receiving satellite signals lowers, the frequency of time correction also lowers, and thus time indication accuracy lowers.

In addition, it is considered that the above illuminance threshold may be decreased in order to increase the receiving frequency. However, when the illuminance threshold decreases excessively, it is incorrectly determined that the electronic device is disposed outdoors in spite of the device being disposed indoors, and the process of receiving a satellite signal may be performed. In this case, the process of receiving a satellite signal is performed in the environments in which there is no capability of receiving satellite signals. That is, a useless process of receiving a satellite signal is performed, and thus the power consumption of the electronic device increases.

### SUMMARY

An advantage of some aspects of the invention is to provide a satellite signal receiving device, an electronic timepiece and a satellite signal receiving method which are capable of suppressing a useless receiving process while improving the frequency of receiving satellite signals.

A satellite signal receiving device according to an aspect of the invention includes: a receiving section that receives a satellite signal transmitted from a position information satellite; a solar cell that converts light energy into electrical energy; and a control section that controls the receiving section and starts a receiving process of the satellite signal, when illuminance of light incident on the solar cell is equal to or greater a preset illuminance threshold within a range of equal to or greater than 1,000 Lx and less than 5,000 Lx.

According to the aspect of the invention, since the illuminance threshold is set to be less than 5,000 Lx, the illuminance of light incident on the solar cell is set to be equal to or greater than the illuminance threshold, even on days, such as cloudy or rainy days, when the sunlight is weak in case where the satellite signal receiving device is disposed outdoors, and the control section starts the receiving process. Thereby, it is possible to improve the frequency of receiving satellite signals.

In addition, maintenance illuminance (value to be maintained so as not to fall below the average illuminance of a certain surface during the period of use) is specified as the illuminance of illumination in house, stores and the like, but there are few places having a maintenance illuminance of equal to or greater 1,000 Lx. For this reason, when the illuminance of ambient light is equal to or greater than 1,000 Lx, it can be determined that the timepiece is located outdoors rather than indoors.

According to the aspect of the invention, since the illuminance threshold is set to be equal to or greater than 1,000 Lx, the illuminance of light incident on the solar cell is to be less than the illuminance threshold with very high probability when the satellite signal receiving device is disposed indoors, and the control section does not start the receiving process. Thereby, it is possible to suppress a useless receiving process of a satellite signal. Therefore, it is possible to reduce the power consumption of the satellite signal receiving device.

In the satellite signal receiving device, it is preferable that the control section starts the receiving process when the illuminance of light incident on the solar cell is equal to or greater than the illuminance threshold, and the illuminance of light incident on the solar cell after a lapse of a predetermined time is equal to or greater than the illuminance threshold.

According to this configuration, when light having the illuminance threshold or greater is not incident on the solar cell, for example, continuously for a certain period of time, the control section does not start the receiving process. For this reason, in a case where the illuminance of light incident on the solar cell increases instantaneously such as, for example, a case where a user passes through a window indoors, the control section does not start the receiving process. Thereby, it is possible to suppress a useless receiving process of a satellite signal. Therefore, it is possible to further reduce the power consumption of the satellite signal receiving device.

In the satellite signal receiving device, it is preferable that the control section terminates the receiving process when the illuminance of light incident on the solar cell during the receiving process is less than the illuminance threshold.

According to this configuration, for example, when the satellite signal receiving device moves indoors from the outdoors during the receiving process and the illuminance of light incident on the solar cell is less than the illuminance threshold, the control section terminates the receiving process. Thereby, it is possible to avoid a state where the receiving process is continuously performed in the state in which there is no capability of receiving satellite signals, and to suppress a useless receiving process of a satellite signal. Therefore, it is possible to further reduce the power consumption of the satellite signal receiving device.

In the satellite signal receiving device, it is preferable that the control section changes the illuminance threshold to a high-illuminance threshold having a higher value in a case of failure in the receiving process, and starts the receiving process when the illuminance of light incident on the solar cell is equal to or greater than the high-illuminance threshold.

For example, when the satellite signal receiving device is disposed indoors with particularly high illuminance, the illuminance of light incident on the solar cell is equal to or greater than the illuminance threshold, and the receiving process is started, but it is assumed that the receiving process is not made successful.

In such a case, according to the configuration described above, the control section changes the illuminance threshold to a high-illuminance threshold having a higher value. Thereby, from the next time, the illuminance of light incident on the solar cell is to be less than the high-illuminance threshold, and it can be expected that the receiving process is not started. Therefore, it is possible to suppress a useless receiving process of a satellite signal, and to further reduce the power consumption of the satellite signal receiving device.

In addition, when the satellite signal receiving device is used in the environment of general illuminance, there are fewer opportunities of the illuminance threshold being changed to the high-illuminance threshold, and the determination is performed on the basis of the illuminance threshold which is set within a range of equal to or greater than 1, 000 Lx and less than 5, 000 Lx. Therefore, it is possible to improve the frequency of receiving satellite signals, and to further suppress a useless receiving process of a satellite signal.

In the satellite signal receiving device, it is preferable that the high-illuminance threshold is set to be within a range of equal to or greater than 1,000 Lx and less than 5,000 Lx.

According to this configuration, even when the illuminance threshold is changed to the high-illuminance threshold, as mentioned above, it is possible to improve the frequency of receiving satellite signals, and to suppress a useless receiving process of a satellite signal.

In the satellite signal receiving device, it is preferable to further include a power generation state detection section that detects a power generation state of the solar cell. It is preferable that the control section determines whether the illuminance of light incident on the solar cell is equal to or greater than the illuminance threshold by comparing a detection value detected in the power generation state detection section with a threshold level determined on the basis of the illuminance threshold and a period of use of the solar cell.

When the period of use of the solar cell gets longer, the solar cell deteriorates and power conversion efficiency drops. For this reason, even when light having the same illuminance is incident on the solar cell, the detection value detected in the power generation state detection section gets lower.

For this reason, when the detection value is compared with the threshold level having always the same value and the period of use of the solar cell gets longer, it may be incorrectly determined that the illuminance of light incident on the solar cell is less than the illuminance threshold in spite of the illuminance of light incident on the solar cell being equal to or greater than the illuminance threshold.

On the other hand, according to the configuration described above, the threshold level is determined on the basis of the illuminance threshold and the period of use of the solar cell. For example, the threshold level decreases as the period of use of the solar cell gets longer. Therefore, even when the period of use of the solar cell gets longer, the determination of whether the illuminance of light incident on the solar cell is equal to or greater than the illuminance threshold can be performed with a high level of accuracy.

An electronic timepiece according to another aspect of the invention includes: the satellite signal receiving device according to the aspect of the invention described above; a clocking section that clocks a time; and a time display section that displays the time clocked by the clocking section. When time information is acquired successfully by the receiving process, the control section corrects the time clocked by the clocking section on the basis of the acquired time information.

According to the aspect of the invention, since the satellite signal receiving device is included, it is possible to improve the frequency of receiving satellite signals. Therefore, it is also possible to improve the frequency of time correction, and to improve time indication accuracy. In addition, since a useless receiving process of a satellite signal can be suppressed, it is possible to reduce the power consumption of the electronic timepiece.

A satellite signal receiving method according to still another aspect of the invention includes: causing light to be incident on a solar cell; and starting a receiving process of a satellite signal when illuminance of light incident on the solar cell is equal to or greater a preset illuminance threshold within a range of equal to or greater than 1,000 Lx and less than 5,000 Lx.

According to the aspect of the invention, it is possible to improve the frequency of receiving satellite signals as is the case with the satellite signal receiving device. Further, it is possible to suppress a useless receiving process of a satellite signal. Therefore, it is possible to reduce the power consumption of the satellite signal receiving device.

### BRIEF DESCRIPTION OF THE DRAWINGS

The invention will be described with reference to the accompanying drawings, wherein like numbers reference like elements.

FIG. 1 is a front view illustrating an electronic timepiece having a satellite signal receiving device according to the invention.

FIG. 2 is a cross-sectional view schematically illustrating the electronic timepiece.

FIG. 3 is a block diagram illustrating a circuit configuration of the satellite signal receiving device.

FIG. 4 is a flow diagram illustrating operations of a control circuit.

FIG. 5 is a diagram illustrating operation timings of the control circuit.

FIG. 6 is a diagram illustrating a relationship between the illuminance of light incident on a solar cell and an open voltage of the solar cell.

FIG. 7 is a diagram illustrating a correspondence relationship between a detection level, an open voltage, and illuminance.

FIG. 8 is a diagram illustrating an example of the weather, the time, and the illuminance of sunlight according to the seasons.

FIG. 9 is a diagram illustrating an example of maintenance illuminance.

FIG. 10 is a diagram illustrating an example of the maintenance illuminance of individual countries.

FIG. 11 is a flow diagram illustrating operations of a control circuit according to a second embodiment.

FIG. 12 is a diagram illustrating a correspondence relationship between a detection level, an open voltage, and illuminance for each period of use of the solar cell.

FIG. 13 is a flow diagram illustrating operations of a control circuit according to a third embodiment.

FIG. 14 is a flow diagram illustrating operations of a control circuit according to a fourth embodiment.

FIG. 15 is a flow diagram illustrating operations of the control circuit according to the fourth embodiment.

FIG. 16 is a flow diagram illustrating operations of a control circuit according to a fifth embodiment.

FIG. 17 is a flow diagram illustrating operations of the control circuit according to the fifth embodiment.

FIG. 18 is a diagram illustrating an example of automatic reception success probability according to automatic reception systems.

### DESCRIPTION OF EXEMPLARY EMBODIMENTS

Hereinafter, specific embodiments of the invention will be described with reference to the accompanying drawings.

### First Embodiment

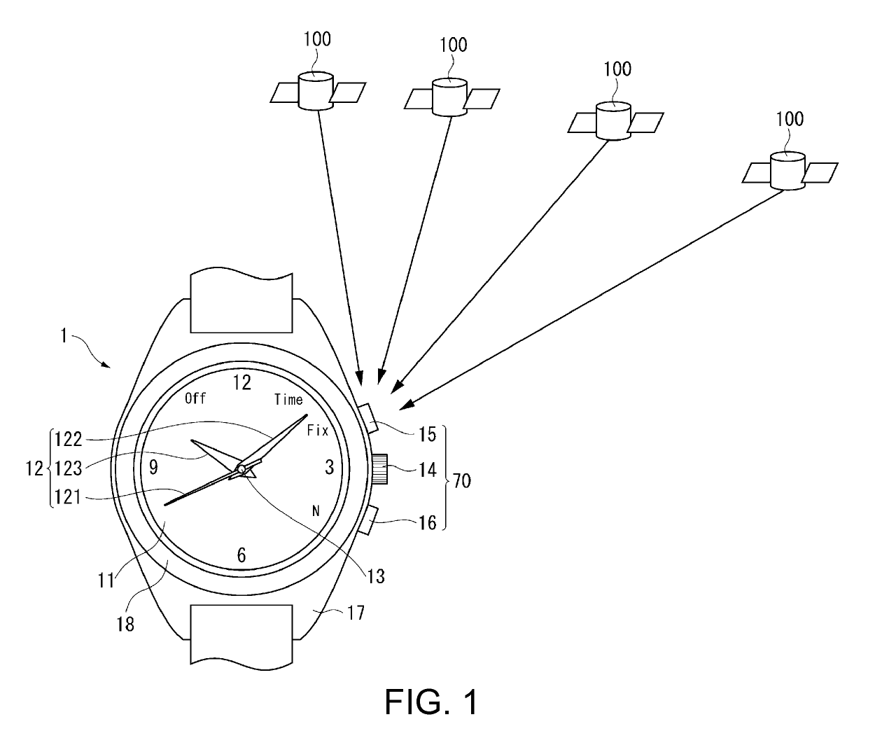

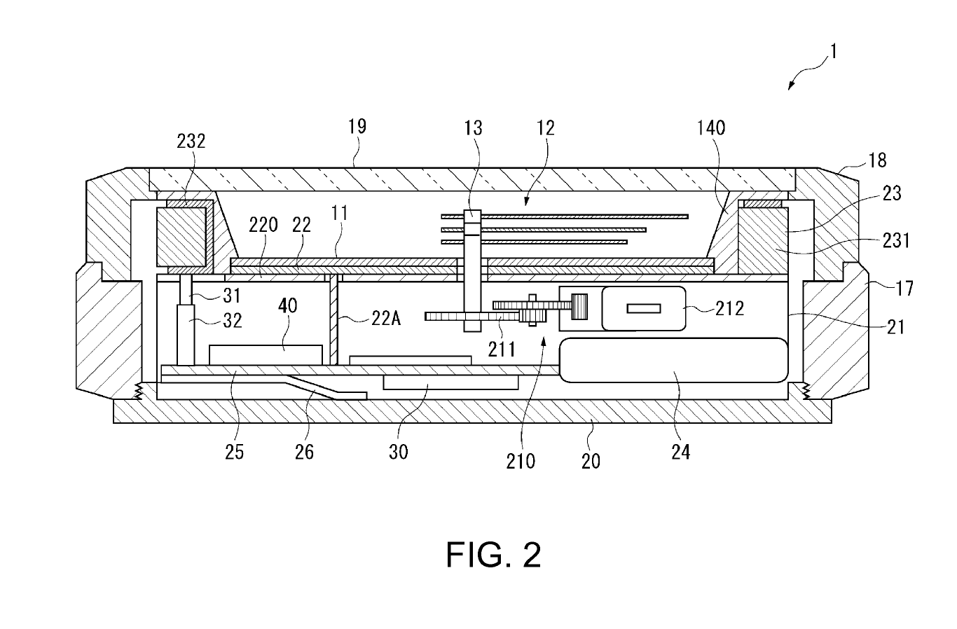

FIG. 1 is a front view illustrating an electronic timepiece 1 having a satellite signal receiving device according to a first embodiment of the invention, and FIG. 2 is a cross-sectional view schematically illustrating the electronic timepiece 1.

As shown in FIG. 1, the electronic timepiece 1 is configured to receive satellite signals from at least one GPS satellite 100 out of a plurality of GPS satellites 100 circling around the Earth at a predetermined orbit to acquire satellite time information, and receive satellite signals from at least three GPS satellites 100 to acquire position information. Meanwhile, the GPS satellite 100 is an example of a position information satellite in the invention, and a plurality of GPS satellites are present in the skies of the Earth. Currently, approximately thirty GPS satellites 100 circle around the Earth.

### Electronic Timepiece

As obvious from FIG. 1, the electronic timepiece 1 is a watch worn on the wrist of a user, includes a character plate 11 and an indicator 12 (time display section) and clocks and displays the time.

Most of the character plate 11 is formed of a non-metallic material (for example, plastic or glass) through which light and microwaves having a band of 1.5 GHz are easily transmitted.

The indicator 12 is provided on the surface side of the character plate 11. In addition, the indicator 12 includes a second hand 121, a minute hand 122 and an hour hand 123 which rotate around a rotating shaft 13, and is driven by a step motor through a toothed wheel.

Operations of Operating Section

In the electronic timepiece 1, processes according to manual operations of an operating section 70 having a crown 14 and buttons 15 and 16 are executed. Specifically, when the crown 14 is operated, a manual correction process of correcting a display time in accordance with the operation is executed. In addition, when the button 15 is pushed over a long period of time (for example, a period of more than three seconds), a manual receiving process (forcible receiving process) for receiving a satellite signal is executed.

In addition, when the button 16 is pushed, a switching process of switching a receiving mode (time measurement mode or positioning mode) is executed. The term “time measurement mode” as used herein refers to a mode for acquiring time information from a satellite signal. In addition, the term “positioning mode” as used herein refers to a mode for acquiring position information by performing a positioning arithmetic operation on the basis of a satellite signal and acquiring time information from a satellite signal. Meanwhile, in the positioning mode, time information may not be acquired from a satellite signal. In this case, when the timepiece is set to be in the positioning mode, the secondhand 121 moves to the position (10 second position) of “Fix”. When the timepiece is set to be in the time measurement mode, the second hand 121 moves to the position (5 second position) of “Time”. For this reason, a user can easily confirm the set receiving mode.

In addition, when the button 15 is pushed for a short period of time (for example, less than 3 seconds), a result display process of displaying the result of the previous receiving process is performed. That is, in a case of a reception success in the positioning mode, the secondhand 121 moves to the position (10 second position) of “Fix”. In a case of a reception success in the time measurement mode, the second hand 121 moves to the position (5 second position) of “Time”. In addition, in a case of a reception failure, the second hand 121 moves to the position (20 second position) of “N”.

Meanwhile, the indication by the second hand 121 is performed even during reception. The second hand 121 moves to the position (10 second position) of “Fix” during reception in the positioning mode, and the second hand 121 moves to the position (5 second position) of “Time” during reception in the time measurement mode. In addition, when the GPS satellite 100 cannot be acquired, the second hand 121 moves to the position (20 second position) of “N”.

### Structure of Electronic Timepiece

As shown in FIG. 2, the electronic timepiece 1 is provided with an outer case 17 made of a metal such as stainless steel (SUS) or titanium. The outer case 17 is formed in a substantially cylindrical shape. A surface glass 19 is installed in an opening on the surface side of the outer case 17 with a bezel 18 interposed therebetween. The bezel 18 is made of a non-metal material such as ceramics in order to improve the reception performance of a satellite signal. A back cover 20 is installed in an opening on the back side of the outer case 17. A movement 21, a solar cell 22, a GPS antenna 23, a secondary battery 24 and the like are disposed inside the outer case 17. Meanwhile, when the timepiece is worn on the wrist of a user, the side of the electronic timepiece 1 worn on the wrist is called the “back side”, and the opposite side thereof (side on which the indicator can be visually recognized) is called the “surface side”.

The movement 21 is configured to be provided with a drive mechanism. 210 including a step motor and a train wheel 211 that drives the indicator 12. The step motor is constituted by a motor coil 212, a stator, a rotor and the like, and drives the indicator 12 through the train wheel 211 and the rotating shaft 13.

A circuit substrate 25 is disposed on the back cover 20 side of the movement 21.

A receiving circuit 30 that processes a satellite signal received in the GPS antenna 23, a control circuit 40 that performs various types of control such as the drive control of the receiving circuit 30 and the step motor, and the like are installed on the circuit substrate 25. The receiving circuit 30 and the control circuit 40 are driven by power supplied from the secondary battery 24.

### Solar Cell

The solar cell 22 is a solar power generation element that performs solar power generation for converting light energy into electrical energy. The solar cell 22 includes an electrode for outputting the generated power, and is disposed on the back side of the character plate 11. Since most of the character plate 11 is formed of a material through which light is easily transmitted, the solar cell 22 can perform solar power generation by receiving light passing through the surface glass 19 and the character plate 11.

The solar cell 22 is supported by a solar panel support substrate 220. The solar panel support substrate 220 is a conductive substrate having a thickness of, for example, 0.1 mm which is formed of a metal material such as, for example, BS (brass), SUS (stainless steel), and a titanium alloy. Thereby, the solar panel support substrate 220 has the same current distribution as that of the GPS antenna 23 disposed adjacent thereto and functions as a portion of the GPS antenna 23.

The solar panel support substrate 220 is incorporated in the outer case 17 so as not to come into contact therewith. That is, the outer circumferential edge of the solar panel support substrate 220 is disposed separately from the inner circumferential surface of the outer case 17 without coming into contact therewith.

The solar cell 22 electrically communicates with the circuit substrate 25 through an electrically conductive coil spring 22A, and a current generated in the solar cell 22 is accumulated in the secondary battery 24 through the electrically conductive coil spring 22A.

Since the character plate 11 and the solar cell 22 are formed so that the respective outer circumferential diameters thereof are in conformity with the inner circumferential diameter of a dial ring 140 and the respective outer circumferences thereof are hidden in the dial ring 140, the solar panel support substrate 220 is not visually recognized from the outside. In addition, the outside size of the solar panel support substrate 220 is larger than the sizes of the solar cell 22 and the character plate 11, and expands to the lower surface of the GPS antenna 23.

### GPS Antenna

The GPS antenna 23 is a ring antenna which includes a ring-shaped dielectric base material 231 having a rectangular cross-sectional shape, and has an antenna electrode 232 formed on the surface thereof.

The dielectric base material 231 is used for shortening the wavelength of a radio wave, and can be formed of, for example, ceramics containing alumina (∈r=8.5) as a main component, so-called Micarex (∈r=6.5 to 9.5) which is a mica-based ceramic, glass (∈r=5.4 to 9.9), diamond (∈r=5.68), or the like.

The antenna electrode 232 is linearly formed integrally with the dielectric base material 231 by printing a conductive metal element such as copper or silver on the surface of the dielectric base material 231, or attaching a conductive metal plate such as silver or copper to the surface of the dielectric base material 231. Meanwhile, the antenna electrode 232 may be formed by forming a pattern on the surface of the dielectric base material 231 using electroless plating.

A connection pin 31 is brought into contact with the antenna electrode 232. The connection pin 31 is inserted into a connection base 32 having a substantially cylindrical shape. The connection base 32 is connected to a printed circuit on the circuit substrate 25 and is disposed upright.

The connection pin 31 and the connection base 32 are electrically connected to the receiving circuit 30 through the printed circuit. The connection base 32 is provided with a biasing member such as, for example, a coil spring in the inside of a cylinder, and biases the connection pin 31 inserted into the connection base 32 against the antenna electrode 232 side. Thereby, the connection pin 31 is pressed against a feeding point of the antenna electrode 232. For example, even when an impact is applied to the electronic timepiece 1, the connection state between the connection pin 31 and the antenna electrode 232 is maintained.

In the embodiment, the back cover 20 made of a conductive member also serves as a ground plate (reflective plate) of the GPS antenna 23. The back cover 20 electrically communicates with a ground terminal 26 provided in the movement 21. The ground terminal 26 is connected to a ground potential of the receiving circuit 30 of the movement 21. For this reason, the back cover 20 is electrically connected to the ground potential of the receiving circuit 30 through the ground terminal 26, and functions as a ground plate (reflective plate) that reflects a radio wave incident from the surface glass 19 side toward the GPS antenna 23. Meanwhile, since the outer case 17 made of a conductive member which comes into contact with the back cover 20 also serves as a ground potential, the outer case 17 also functions as a ground plate.

Further, the back cover 20 and the outer case 17 are made of a metal, and thus can avoid an influence on the GPS antenna 23 when the timepiece is worn on the arm of a user, in addition to the function as a ground plate. That is, when the case is a plastic case, the resonance frequency of the GPS antenna 23 fluctuates under the influence of the arm located adjacent to the case at the time of wearing and not wearing of the timepiece, and thus performance difference occurs, which leads to an undesirable result. However, since the case is made of a metal, it is possible to avoid the influence of the arm in virtue of the shielding effect, and to obtain stable reception performance with little difference in antenna characteristics between at the time of wearing of the timepiece and at the time of non-wearing thereof in the embodiment. However, it is also possible to adopt a plastic case.

### Secondary Battery

The secondary battery 24 is a power source of the electronic timepiece 1, and accumulates power generated in the solar cell 22.

In the electronic timepiece 1, two electrodes of the solar cell 22 and two electrodes of the secondary battery 24 can be respectively electrically connected to each other by two electrically conductive coil springs 22A, and the secondary battery 24 is charged by the solar power generation of the solar cell 22 during the connection. Meanwhile, in the embodiment, a lithium ion battery suitable for a portable device is used as the secondary battery 24. However, a lithium polymer battery or other secondary batteries may be used, and a charging body (for example, capacitive element) different from the secondary battery may be used.

### Circuit Configuration of Satellite Signal Receiving Device

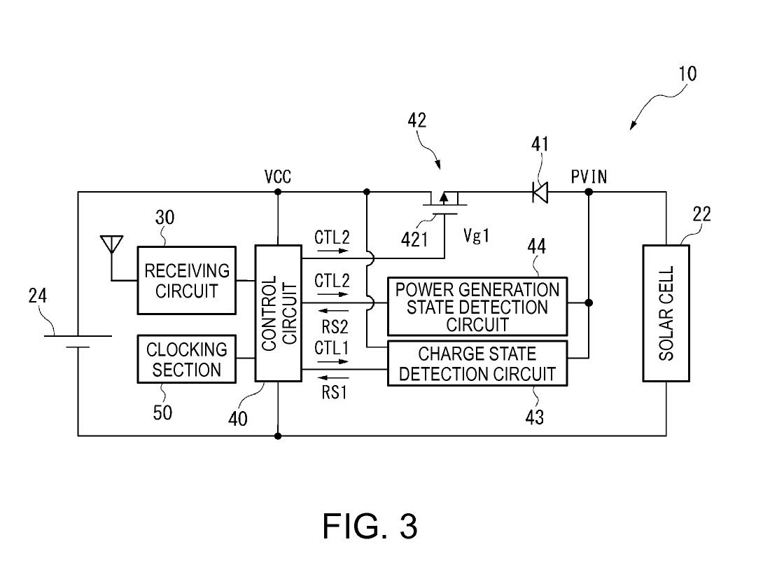

FIG. 3 is a block diagram illustrating a circuit configuration of a satellite signal receiving device 10 in the electronic timepiece 1. As shown in the drawing, the satellite signal receiving device 10 includes the solar cell 22, the secondary battery 24, the receiving circuit 30 (receiving section), the control circuit 40 (control section), a diode 41, a charge control switch 42, a charge state detection circuit 43 (charge state detection section), a power generation state detection circuit 44 (power generation state detection section), and a clocking section 50.

The control circuit 40 is constituted by a CPU for controlling the satellite signal receiving device 10. The control circuit 40 controls the receiving circuit 30 to execute a receiving process, as described later. In addition, the control circuit 40 controls operations of the charge state detection circuit 43 and the power generation state detection circuit 44.

The diode 41 is provided in a path for electrically connecting the solar cell 22 and the secondary battery 24, and cuts off a current (backward current) from the secondary battery 24 to the solar cell 22 without cutting off a current (forward current) from the solar cell 22 to the secondary battery 24. Meanwhile, the flow of a forward current is limited to a case where the voltage of the solar cell 22 is higher than the voltage of the secondary battery 24, that is, the time of charge corresponding to a state in which light is incident on the solar cell 22. In addition, a field effect transistor (FET) may be adopted instead of the diode 41.

The charge control switch 42 is used for connecting and disconnecting the path of a current from the solar cell 22 to the secondary battery 24, and includes a switching element 421 provided in the path for electrically connecting the solar cell 22 and the secondary battery 24. The switching element 421 is turned on (connected) when transitioning from an off-state to an on-state, and the switching element 421 is turned off (disconnected) when transitioning from an on-state to an off-state.

For example, when the battery voltage of the secondary battery 24 is equal to or greater than a predetermined value, the charge control switch 42 is turned off so as not to be in a state where battery characteristics deteriorate due to overcharge.

The switching element 421 is a p-channel type transistor, and is set to be in an on-state when a gate voltage Vg1 is at a low level and is set to be in an off-state when the gate voltage is at a high level. The gate voltage Vg1 is controlled by the control circuit 40.

The charge state detection circuit 43 operates on the basis of a binary control signal CTL1 for specifying the detection timing of a charge state, detects the state of charge from the solar cell 22 to the secondary battery 24, and outputs a detection result RS1 to the control circuit 40. The charge state is “charging” or “non-charging”, and the detection thereof is performed on the basis of a battery voltage VCC and PVIN of the solar cell 22 when the charge control switch 42 is turned on. For example, when the voltage drop of the diode 41 is set to Vth and the on-resistance of the switching element 421 is ignored, it can be determined to be “charging” when PVIN-Vth>VCC, and it can be determined to be “non-charging” when PVIN-VthVCC.

In the embodiment, the control signal CTL1 is a pulse signal having a period of one second, and the charge state detection circuit 43 detects the charge state in a period of time when the control signal CTL1 is at a high level. That is, the charge state detection circuit 43 repeatedly detects the charge state in a period of one second while the charge control switch 42 is maintained to be in a connection state.

Meanwhile, the reason for the intermittent detection of the charge state is because the amount of power consumption of the charge state detection circuit 43 is reduced. When the reduction is unnecessary, the charge state may be continuously detected. The charge state detection circuit 43 can be constituted by using, for example, a comparator, an A/D converter and the like.

The power generation state detection circuit 44 operates on the basis of a binary control signal CTL2 for specifying the detection timing of a voltage, and detects the terminal voltage PVIN of the solar cell 22, that is, an open voltage corresponding to a state where the solar cell 22 is not connected to the secondary battery 24, in a period of time when the charge control switch 42 is turned off by the control signal CTL2. In addition, the power generation state detection circuit 44 outputs a detection result RS2 of the open voltage to the control circuit 40. As is the case with the charge state detection circuit 43, the power generation state detection circuit 44 can be constituted by using, for example, a comparator, an A/D converter and the like.

The clocking section 50 includes the movement 21, and is driven by power accumulated in the secondary battery 24 to perform a clocking process. In the clocking process, the time is clocked, while the time (display time) according to the clocking time is displayed on the surface of the electronic timepiece 1.

### Operations of Control Circuit

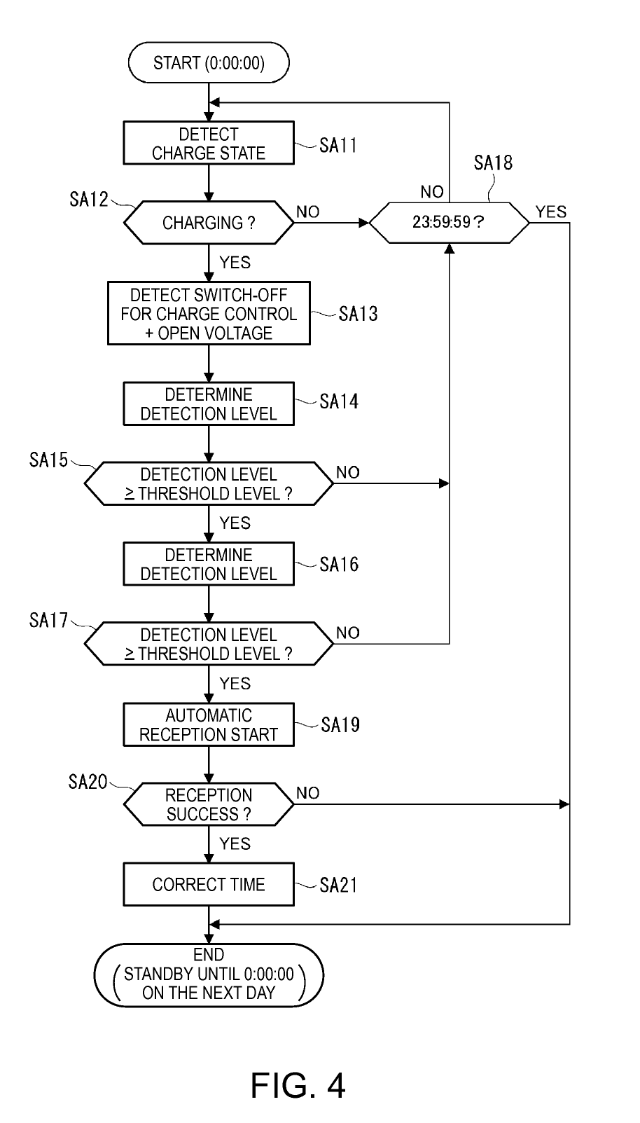

Operations of the control circuit 40 in such a satellite signal receiving device 10 will be described with reference to the flow diagram of FIG. 4.

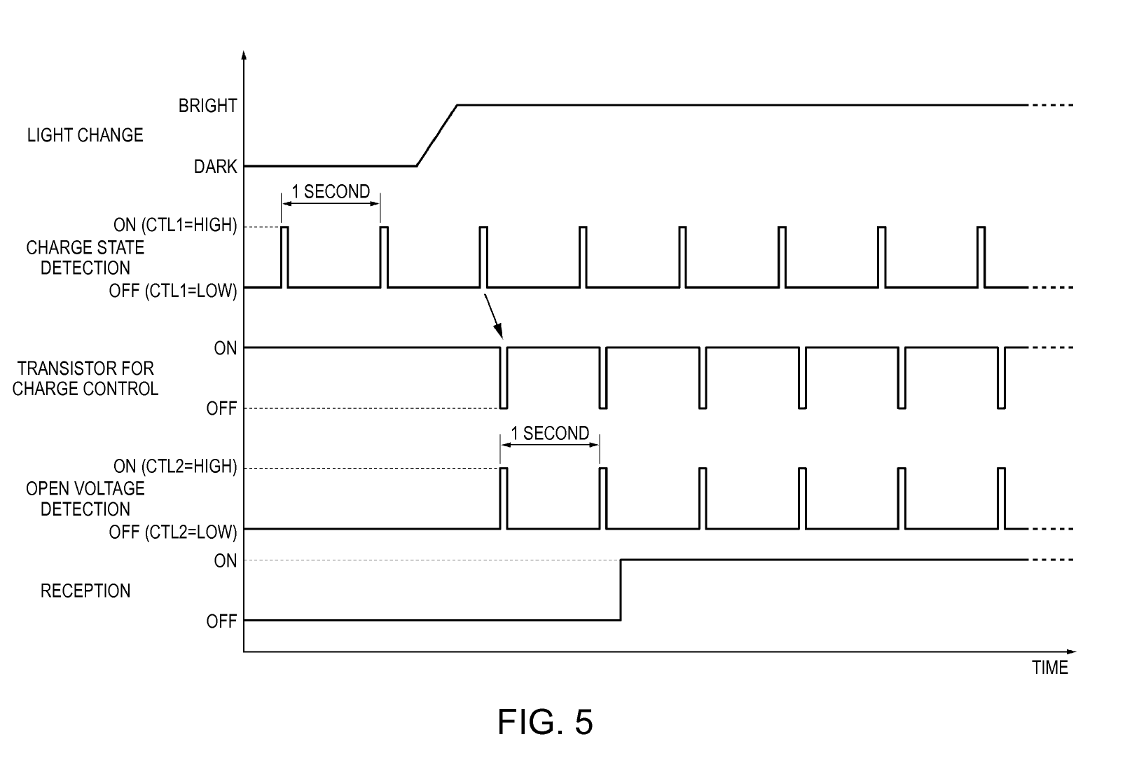

The control circuit 40 starts control at 00:00:00 every day. First, the control circuit 40 brings the charge state detection circuit 43 into operation at a constant period (SA11). In the embodiment, as shown in FIG. 5, the control circuit 40 outputs the control signal CTL1 with a one second interval, and brings the charge state detection circuit 43 into operation. When the control signal CTL1 is input, the charge state detection circuit 43 outputs the detection result RS1 indicating whether to being in a charge state to the control circuit 40. For this reason, the control circuit 40 determines whether there is charging (SA12). Meanwhile, the charge control switch 42 is switched to an off-state only at a timing when the power generation state detection circuit 44 is brought into operation.

### Control in Non-Charge State

When light is not incident on the solar cell 22 of the electronic timepiece 1, the charge state detection circuit 43 outputs the detection result RS1 of “non-charging” to the control circuit 40. In this case, the control circuit 40 determines the charge state as non-charging (SA12: NO), and outputs the low-level control signal CTL2 from the control circuit 40.

Therefore, when the determination result of SA12 is NO, the control circuit 40 can determine that it is more likely that the electronic timepiece 1 may not be disposed outdoors, and may not be disposed at a place suitable for receiving a satellite signal.

### Control in Charge State

On the other hand, when it is determined to be in a charge state in SA12 (SA12: YES), the control circuit 40 brings the power generation state detection circuit 44 into operation (SA13). In this case, as mentioned above, the charge control switch 42 is switched to an off-state by the control circuit 40. That is, when it is detected by the charge state detection circuit 43 that the charge state is charging, the control circuit 40 outputs the control signal CTL2 with a one second interval, and brings the power generation state detection circuit 44 into operation. In this case, since the charge control switch 42 is controlled to be in an off-state by the control signal CTL2 from the control circuit 40, the solar cell 22 and the power generation state detection circuit 44 are disconnected from the secondary battery 24. For this reason, the power generation state detection circuit 44 can detect an open voltage corresponding to the illuminance of light incident on the solar cell 22 without being influenced by the charge voltage of the secondary battery 24.

Meanwhile, when the charge control switch 42 is in an off-state, the charge state cannot be detected by the charge state detection circuit 43. For this reason, the control circuit 40 shifts output timings of the control signal CTL1 and the control signal CTL2 so that an output timing of the control signal CTL1 for the charge state detection circuit 43 and an output timing of the control signal CTL2 for the power generation state detection circuit 44 do not conform with each other.

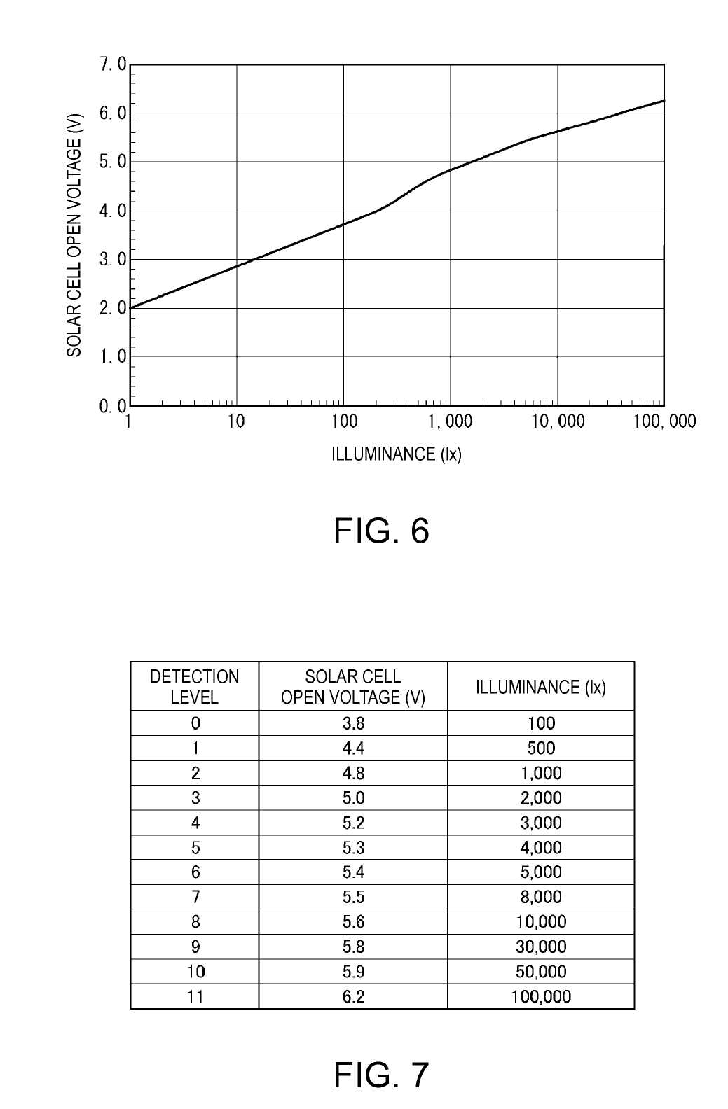

In the embodiment, as shown in FIG. 6, the open voltage detected in the power generation state detection circuit 44 increases as illuminance in the solar cell 22 gets higher.

In addition, for the power generation state detection circuit 44, a configuration may be used in which the illuminance of light incident on the solar cell 22 is detected by detecting a short-circuit current of the solar cell 22 instead of the open voltage of the solar cell 22. That is, a configuration may be applied in which a short-circuit current increasing as the illuminance in the solar cell 22 gets higher is detected. Meanwhile, even in the configuration in which a short-circuit current is detected, as is the case with the configuration in which an open voltage is detected, it is necessary to prevent the influence of the secondary battery 24 by turning off the charge control switch 42 to electrically disconnect the solar cell 22 and the secondary battery 24.

Such an open voltage and short-circuit current have a correlation with an output value in the solar cell 22. Consequently, in the embodiment, the open voltage or the short-circuit current is detected as a detection value.

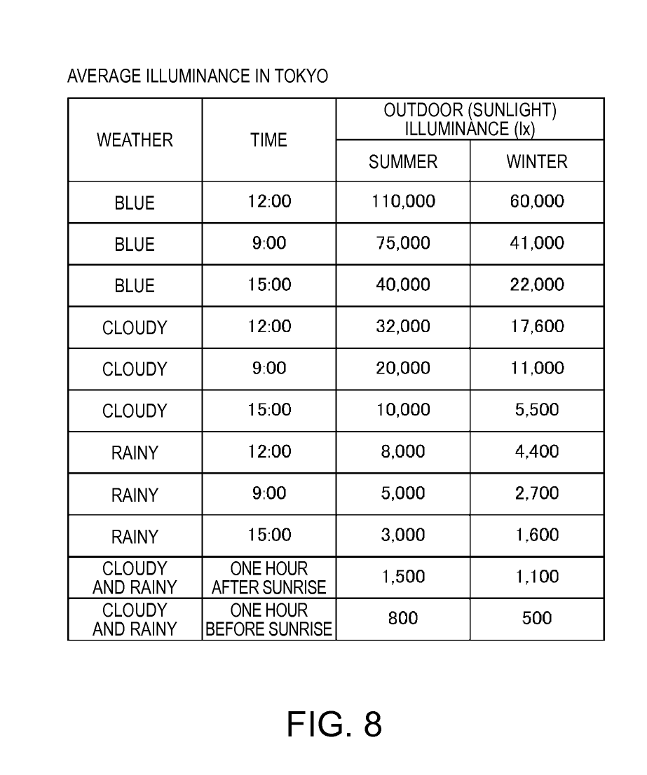

The control circuit 40 determines a detection level corresponding to the open voltage on the basis of the detection result RS2 which is output from the power generation state detection circuit 44 (SA14). In the embodiment, the control circuit 40 determines the detection level on the basis of a relation shown in FIG. 7. FIG. 7 shows a correspondence relationship between the detection level, the open voltage of the solar cell 22, and illuminance. Meanwhile, the open voltage and the illuminance in FIG. 7 represent a lower limit in each detection level. For example, the control circuit 40 determines that the detection level is “2” when the open voltage is equal to or greater than 4.8 V and less than 5.0 V, and that the detection level is “3” when the open voltage is equal to or greater than 5.0 V and less than 5.2 V.

As shown in FIG. 4, the control circuit 40 determines whether the detection level determined in SA14 is equal to or greater than a threshold level (SA15).

Here, the threshold level is set to a detection level corresponding to a preset illuminance threshold on the basis of the relation shown in FIG. 7. Meanwhile, the illuminance threshold is a threshold which is preset in order to determine whether the electronic timepiece 1 is disposed indoors or disposed outdoors, with reference to the illuminance of light incident on the solar cell 22.

That is, the control circuit 40 can determine whether the illuminance of light incident on the solar cell 22 is equal to or greater than the preset illuminance threshold by determining whether the detection level is equal to or greater than the threshold level. Therefore, when the determination result of SA15 is NO, the control circuit 40 can determine that it is more likely that the electronic timepiece 1 may not be disposed outdoors, and may not be disposed at a place suitable for receiving a satellite signal.

Here, the illuminance threshold is set to be within a range of equal to or greater than 1,000 Lx (lux) and less than 5,000 Lx. That is, in the relation shown in FIG. 7, the detection levels corresponding to the illuminance within this range are “2”, “3”, “4”, and “5”, and the threshold level is set to one of these values.

Here, the reason to set the illuminance threshold to be within a range of equal to or greater than 1,000 Lx and less than 5,000 Lx will be described.

The outdoor illuminance of ambient light changes with the weather, the time and the season. As shown in FIG. 8, the outdoor illuminance reaches equal to or greater than 5,000 Lx in sunny days both in the summer and winter, but falls below 5,000 Lx at 15 o'clock on rainy days in the summer, rainy days in the winter, or the like. For this reason, for example, when the illuminance threshold is set to be equal to or greater than 5,000 Lx, the illuminance reaches less than the illuminance threshold at 15 o'clock on rainy days in the summer, rainy days in the winter, or the like even in a case where the electronic timepiece 1 is disposed outdoors. Therefore, it is incorrectly determined that the electronic timepiece is disposed indoors.

On the other hand, when the illuminance threshold is set to be less than 5,000 Lx, it can be detected that the electronic timepiece 1 is disposed outdoors even at 15 o'clock on rainy days in the summer, rainy days in the winter, or the like. For example, when the illuminance threshold is set to be 1,000 Lx, an hour after sunrise, it can be detected that the electronic timepiece 1 is disposed outdoors regardless of the weather and the season.

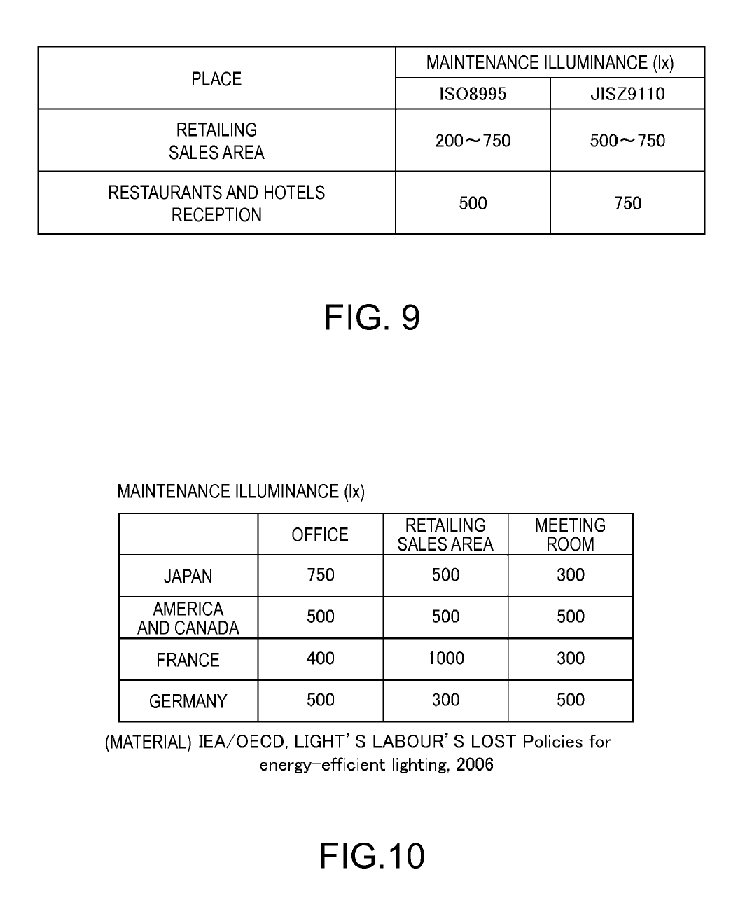

In addition, as the illuminance of illumination in houses, stores and the like, maintenance illuminance (value to be maintained so as not to fall below the average illuminance of a certain surface during the period of use) are specified by ISO (International Organization for Standardization)8995 and JIS (Japanese Industrial Standards) Z9110. For example, as shown in FIG. 9, maintenance illuminance within retailing sales area is 200 to 750 Lx in ISO8995, and is 500 to 750 Lx in JISZ9110. In addition, maintenance illuminance in receptions of restaurants and hotels is 500 Lx in IS08995, and is 750 Lx in JISZ9110. Even though referring to other items of ISO8995 and JISZ9110, there are few places having a maintenance illuminance of equal to or greater than 1,000 Lx in “houses”, except for special places in which works such as handicraft, needlework, sewing machine are performed. In addition, there are few places having a maintenance illuminance of equal to or greater than 1,000 Lx even in “stores, department stores, and others”, except for special places such as sales area priority exhibitions.

In addition, as maintenance illuminance, different values are specified in individual countries. As shown in FIG. 10, all the maintenance illuminance values of offices, retailing sales area, meeting room and the like of individual countries fall below 1,000 Lx, except for retailing sales area of France in which maintenance illuminance is specified as 1,000 Lx.

As stated above, in the inside of the house, there is little possibility of the illuminance of ambient light being equal to or greater than 1,000 Lx. Therefore, the illuminance threshold is set to be equal to or greater than 1,000 Lx, thereby allowing a case where the electronic timepiece 1 is located indoors to be correctly determined.

From the above reason, in the embodiment, the illuminance threshold is set to be within a range of equal to or greater than 1,000 Lx and less than 5,000 Lx.

As shown in FIG. 4, when the detection level is equal to or greater than the threshold level and thus the determination result of SA15 is YES, the control circuit 40 determines the detection level corresponding to the open voltage again on the basis of the relation shown in FIG. 7, depending on the detection result RS2 which is output from the power generation state detection circuit 44 after the lapse of a certain time (for example, a second) (SA16). The control circuit 40 then determines whether the detection level determined in SA16 is equal to or greater than the threshold level (the same level as the threshold level of SA15) (SA17).

In this manner, after the determination result of SA15 is YES, the control circuit 40 determines whether light having the illuminance threshold or greater is incident on the solar cell 22 continuously for a certain period of time.

When the threshold level is set to, for example, “3” in SA15, the threshold level is also set to “3” in SA17.

When the determination results of any of SA12, SA15, and SA17 are NO, it is determined whether the current time is before 23:59:59 of a day when the control circuit 40 starts control (SA18). In this manner, the control circuit 40 determines whether a preset time elapses without performing a receiving process. In the embodiment, the preset time is 24 hours from 0:00:00 to 23:59:59. When the determination result of SA18 is NO, the flow returns to SA11, and the charge state detection circuit 43 is brought into operation at a constant period.

On the other hand, when the determination result of SA18 is YES, the process is terminated, and the flow proceeds to a standby state until the control restart time when the process in the control circuit 40 is next started. Here, the control restart time is 0:00:00 on the next day.

When the determination result of SA17 is YES, it can be determined that the electronic timepiece 1 is located outdoors, and thus the control circuit 40 brings the receiving circuit 30 into operation to start the receiving process of a satellite signal (SA19).

Meanwhile, the receiving process started in SA19 is an automatic receiving process automatically performed falling under a predetermined condition. In such an automatic receiving process, the receiving process in the time measurement mode is performed. That is, in the positioning mode, signals have to be received from three or more GPS satellites 100 in order to detect a position, and the receiving process time also gets longer. For this reason, it is preferable to dispose the electronic timepiece 1 outdoors until the signal reception is terminated. However, in the automatic receiving process, there is also a concern that a user may move indoors even during reception without noticing a signal being received. For this reason, the reception in the positioning mode is preferably performed only when a user performs a receiving operation intentionally, that is, only when a forcible receiving process is performed.

On the other hand, in the time measurement mode, time information can be acquired even in signal reception from one GPS satellite 100, and the receiving process time can also be shortened. Therefore, the receiving process can be executed even without a user's intention, and thus the time measurement mode is suitable for the automatic receiving process.

As shown in FIG. 4, the control circuit 40 determines whether the reception of a satellite signal is made successful by the receiving process started in SA19 (SA20).

Meanwhile, in the receiving circuit 30, the searching of the GPS satellite 100 is first performed, and a satellite signal is detected in the receiving circuit 30. When the satellite signal is detected, the reception of the satellite signal is continuously performed, and time information is received. When the time information can be received in this manner, it is determined that the reception of the satellite signal is made successful by the receiving process. In other cases, that is, when the satellite signal cannot be detected in the receiving circuit 30, or when the time information cannot be received, it is determined that the reception of the satellite signal is not made successful by the receiving process.

When it is determined that the reception of the satellite signal is made successful by the receiving process (SA20: YES), the control circuit 40 corrects the time clocked by the clocking section 50 on the basis of the received time information (SA21) and terminates the process, and the flow proceeds to a standby state until 0:00:00 on the next day which is the control restart time.

On the other hand, when it is determined that the reception of the satellite signal is not made successful by the receiving process (SA20: NO), the process is terminated, and the flow proceeds to a standby state until 0:00:00 on the next day which is the control restart time.

### Operations and Effects of First Embodiment

According to the above first embodiment, the following operations and effects are obtained.

Since the illuminance threshold is set to be less than 5,000 Lx, the detection level obtained as the determination results in SA14 and SA16 is set to equal to or greater than the threshold level corresponding to the illuminance threshold, even on days, such as cloudy or rainy days, when the sunlight is weak in a case where the electronic timepiece 1 is disposed outdoors (SA17: YES), and the control circuit 40 starts the receiving process of a satellite signal (SA19). Thereby, it is possible to improve the frequency of receiving satellite signals. Therefore, it is also possible to improve the frequency of time correction, and to improve time indication accuracy.

In addition, maintenance illuminance is specified as the illuminance of illumination in house, stores and the like, but there are few places having a maintenance illuminance of equal to or greater than 1,000 Lx. For this reason, when the illuminance of ambient light is equal to or greater than 1,000 Lx, it can be determined that the timepiece is located outdoors rather than indoors.

According to the first embodiment, since the illuminance threshold is equal to or greater than 1,000 Lx, the detection level obtained as the determination result in SA14 is set to be less than the threshold level with very high probability when the electronic timepiece 1 is disposed indoors (SA15: NO), and the control circuit 40 does not start the receiving process. Thereby, it is possible to suppress a useless receiving process of a satellite signal. Therefore, it is possible to reduce the power consumption of the electronic timepiece 1.

When it is determined that the detection level obtained as the determination result in SA14 is equal to or greater than the threshold level (SA15: YES), the control circuit 40 determines whether the detection level obtained as the determination result in SA16 after the lapse of a predetermined time is equal to or greater than the threshold level (SA17). When it is determined that the detection level is equal to or greater than the threshold level (SA17: YES), the control circuit starts the receiving process of a satellite signal (SA19).

According to this, when light having the illuminance threshold or greater is not incident on the solar cell 22 continuously for a certain period of time, the control circuit 40 does not start the receiving process. For this reason, in a case where the illuminance of light incident on the solar cell 22 increases instantaneously such as, for example, a case where a user passes through a window indoors, the control circuit 40 does not start the receiving process. Thereby, it is possible to suppress a useless receiving process of a satellite signal. Therefore, it is possible to further reduce the power consumption of the electronic timepiece 1.

In the first embodiment, when the threshold level is set to, for example, “3” in SA15, the threshold level is also set to “3” in SA17. However, when stay outdoors is determined more carefully, the threshold level may be changed within a range of “2”, “3”, “4”, and “5” which is within a range of equal to or greater than 1,000 Lx and less than 5,000 Lx. For example, the threshold level may be set to “3” in SA15, and may be set to “4” in SA17 by raising a detection level by one.

In the first embodiment, since the current consumption of the power generation state detection circuit 44 is larger than that of the charge state detection circuit 43, the charge state is detected in the charge state detection circuit 43 so that the power generation state detection circuit 44 is not brought into operation insofar as possible (SA11), and the power generation state detection circuit 44 is brought into operation only at the time of charging corresponding to a state where light is incident on the solar cell 22 (SA13). When the battery capacity of the secondary battery 24 is sufficient and thus large current consumption does not matter, charge state detection may be omitted, and it may be determined whether light having the illuminance threshold or greater is incident on the solar cell 22 by bringing the power generation state detection circuit 44 into operation, in any of the charge state and the non-charge state.

### Second Embodiment

Next, a second embodiment of the invention will be described with reference to the accompanying drawings.

Meanwhile, the description of the same content as that of the first embodiment will be omitted.

In the first embodiment, a threshold level is fixed to any of “2” to “5” which are the detection levels corresponding to the illuminance threshold set within a range of equal to or greater than 1,000 Lx and less than 5,000 Lx. However, in the second embodiment, the threshold level can be changed to a detection level corresponding to a high-illuminance threshold having a higher value than the illuminance threshold.

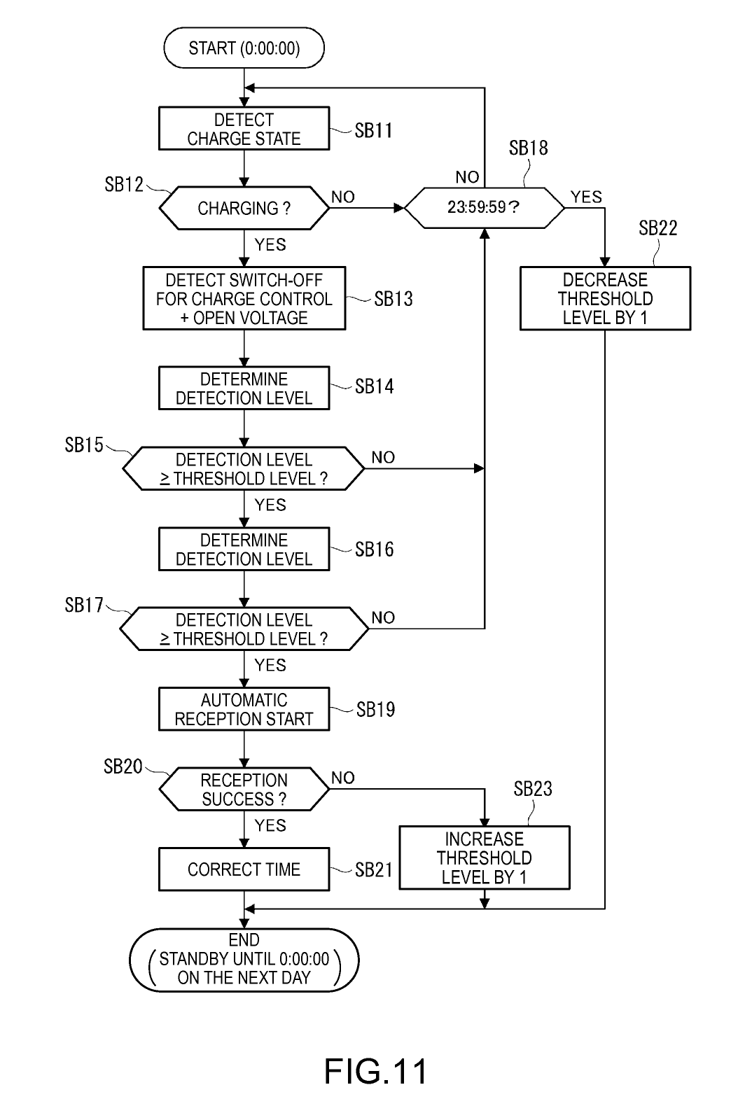

FIG. 11 is a flow diagram illustrating operations of a control circuit 40 according to the second embodiment.

As shown in FIG. 11, the control circuit 40 performs processes of SB11 to SB23. Here, the processes of SB11 to SB21 are the same processes as SA11 to SA21 in the first embodiment, and thus the description thereof will be omitted.

In the first embodiment, when the determination result of SA18 is YES, the control circuit 40 terminates the process as it is. In addition, when it is determined in SA20 that the reception is not made successful (SA20: NO), the control circuit 40 terminates the process as it is.

On the other hand, in the second embodiment, when the determination result of SB18 is YES, the control circuit 40 changes the threshold level to a detection level which is one level lower (SB22), and terminates the process. In addition, when it is determined in SB20 that the reception is not made successful (SB20: NO), the control circuit 40 changes threshold level to a detection level which is one level higher (SB23), and terminates the process. Meanwhile, any of “2” to “5” which are the detection levels corresponding to the illuminance threshold set within a range of equal to or greater than 1,000 Lx and less than 5,000 Lx is set as an initial value of the threshold level.

According to the above second embodiment, the same operations and effects are obtained by the same processes as those of the first embodiment, and thus the following operations and effects are obtained.

For example, when the electronic timepiece 1 is disposed indoors with particularly high illuminance, the detection level obtained as the determination results in SB14 and SB16 is set to be equal to or greater than the threshold level corresponding to the illuminance threshold which is set within a range of equal to or greater than 1,000 Lx and less than 5,000 Lx (SB17: YES), and the receiving process of a satellite signal is started in SB19, but it is assumed that the receiving process is not made successful.

In such a case, according to the second embodiment, the control circuit 40 changes the threshold level to a detection level which is one level higher (SB23). That is, the control circuit 40 changes the threshold level to a detection level corresponding to a high-illuminance threshold having a higher value than the illuminance threshold. Thereby, from the next time, the detection level obtained as the determination result in SB14 is less than the threshold level (SB15: NO), and it can be expected that the receiving process is not started. Therefore, it is possible to suppress a useless receiving process of a satellite signal, and to further reduce the power consumption of the electronic timepiece 1.

In addition, when the receiving process of a satellite signal is not started even after waiting all day (SB18: YES), the control circuit 40 changes the threshold level to a detection level which is one level lower (SB22). Thereby, it is possible to suppress a decrease in the frequency of receiving satellite signals due to an excessive increase in the threshold level.

In addition, when the electronic timepiece 1 is used in the environment of general illuminance, there are fewer opportunities of the threshold level being changed to a detection level corresponding to a high-illuminance threshold, and the determination is performed on the basis of the initial value, that is, the threshold level corresponding to the illuminance threshold which is set within a range of equal to or greater than 1,000 Lx and less than 5,000 Lx. Therefore, it is possible to improve the frequency of receiving satellite signals, and to further suppress a useless receiving process of a satellite signal.

Meanwhile, the high-illuminance threshold may be a higher threshold than the illuminance threshold which is set within a range of equal to or greater than 1,000 Lx and less than 5,000 Lx. For example, the threshold level corresponding to the high-illuminance threshold may be set so as to satisfy a range of equal to or greater than 1,000 Lx and less than 5,000 Lx, and may be able to be set to be equal to or greater than 5,000 Lx (equal to or greater than the detection level of “6”). In the latter case, at least the initial value is set within a range of equal to or greater than 1,000 Lx and less than 5,000 Lx.

### Third Embodiment

Next, a third embodiment of the invention will be described with reference to the accompanying drawings.

Meanwhile, the description of the same content as that of the first embodiment will be omitted.

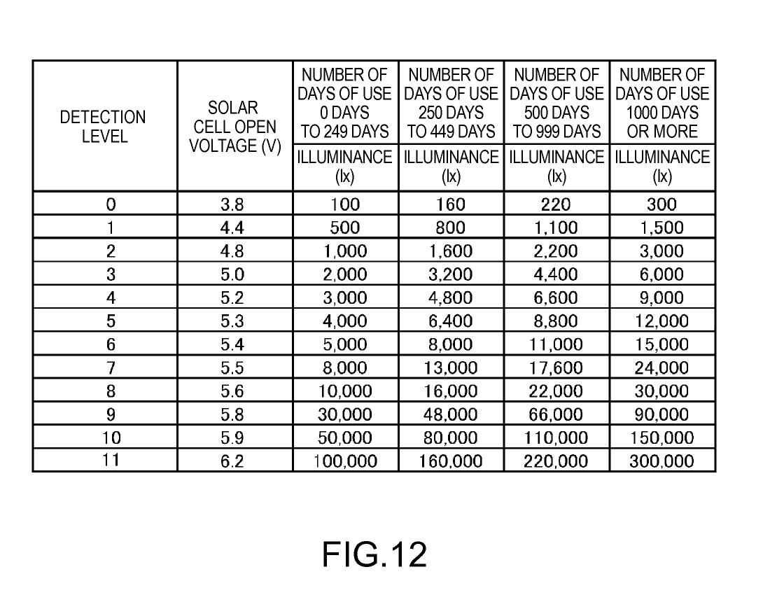

In the first embodiment, the threshold level is set to a detection level corresponding to the illuminance threshold which is set within a range of equal to or greater than 1,000 Lx and less than 5,000 Lx, on the basis of the relation shown in FIG. 7. However, in the third embodiment, the threshold level is set on the basis of a relation shown in FIG. 12.

FIG. 12 illustrates a correspondence relationship between the detection level, the open voltage of the solar cell 22, and illuminance for each period of use. Meanwhile, the open voltage and the illuminance in FIG. 12 represent a lower limit in each detection level.

Here, when the number of days of use of the solar cell 22 gets longer, the solar cell 22 deteriorates and power conversion efficiency drops. For this reason, as shown in FIG. 12, even when light having the same illuminance is incident on the solar cell 22, the open voltage decreases as the number of days of use gets longer, and the corresponding detection level is to be a low value.

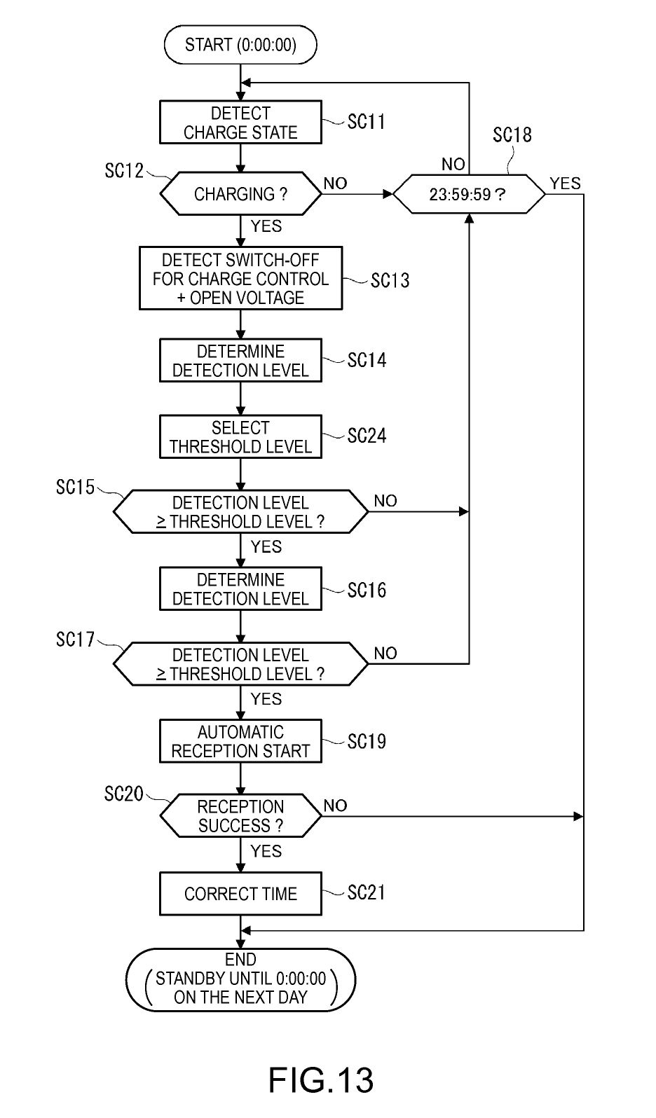

FIG. 13 is a flow diagram illustrating operations of a control circuit 40 according to the third embodiment.

As shown in FIG. 13, the control circuit 40 performs processes of SC11 to SC21 and SC24. Here, the processes of SC11 to SC21 are the same processes as SA11 to SA21 in the first embodiment, and thus the description thereof will be omitted.

In the first embodiment, the control circuit 40 determines the detection level in SA14, and then determines whether the detection level is equal to or greater than the threshold level in SA15 as it is.

On the other hand, in the third embodiment, the control circuit 40 determines the detection level in SC14, and then selects, as the threshold level, the number of days of use of the solar cell 22 and a detection level corresponding to the illuminance threshold which is set within a range of equal to or greater than 1,000 Lx and less than 5,000 Lx, on the basis of the relation shown in FIG. 12 (SC24).

For example, in a case where the illuminance threshold is 2000 Lx, the detection level “3” is selected as the threshold level when the number of days of use is 0 days to 249 days, and the detection level “1” is selected as the threshold level when the number of days of use is 1,000 days or more.

In SC15 and SC17, it is determined whether the detection level obtained as the determination results in SC14 and SC16 is equal to or greater than the threshold level selected in SC24.

Meanwhile, the number of days of use can be calculated as follows.

For example, at the time of factory shipment of the electronic timepiece 1, or the like, the date at that point in time is stored in a storage section of the control circuit 40. In SC14, after the detection level is determined, a difference between the date at this point in time clocked in the clocking section 50 and the stored factory shipment date is calculated, and the number of days elapsed (the number of days of use) from the factory shipment is acquired. In the date at this point in time, the time including the date clocked by the clocking section 50 is corrected for each reception success on the basis of the received time information, and thus the date at this point in time can be obtained. For example, regarding the number of days of use, when the factory shipment date stored in the storage section of the control circuit 40 is Jan. 1, 2013 and the date at this point in time is Jan. 1, 2014, the difference therebetween can be calculated as 365 days.

According to the above third embodiment, the same operations and effects are obtained by the same processes as those of the first embodiment, and thus the following operations and effects are obtained.

When the period of use of the solar cell 22 gets longer, the solar cell 22 deteriorates and power conversion efficiency drops. For this reason, even when light having the same illuminance is incident on the solar cell 22, the detection level obtained as the determination results in SC14 and SC16 is set to be a low value when the period of use of the solar cell 22 gets longer.

For this reason, when the detection level is compared with the threshold level having always the same value and the period of use of the solar cell 22 gets longer, the detection level is set to be less than the threshold level in spite of the illuminance of light incident on the solar cell 22 being equal to or greater than the illuminance threshold, and thus it may be incorrectly determined that the illuminance of light incident on the solar cell 22 is less than the illuminance threshold.

On the other hand, according to the third embodiment, the threshold level is selected on the basis of the illuminance threshold and the period of use of the solar cell 22. That is, the threshold level decreases as the period of use of the solar cell 22 gets longer. Therefore, even when the period of use of the solar cell 22 gets longer, the determination of whether the illuminance of light incident on the solar cell 22 is equal to or greater than the illuminance threshold can be performed with a high level of accuracy.

### Fourth Embodiment

Next, a fourth embodiment of the invention will be described with reference to the accompanying drawings.

Meanwhile, the description of the same content as that of the first embodiment will be omitted.

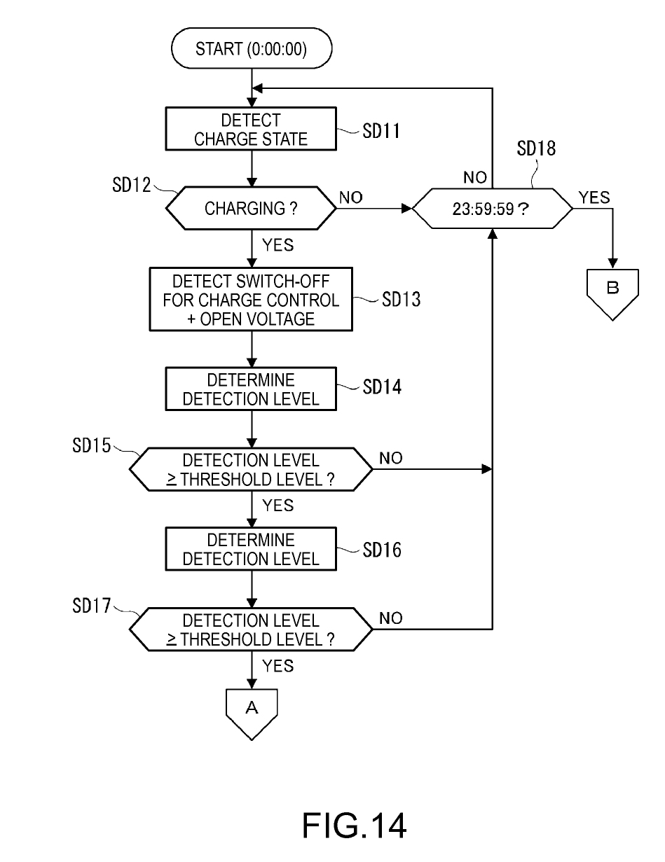

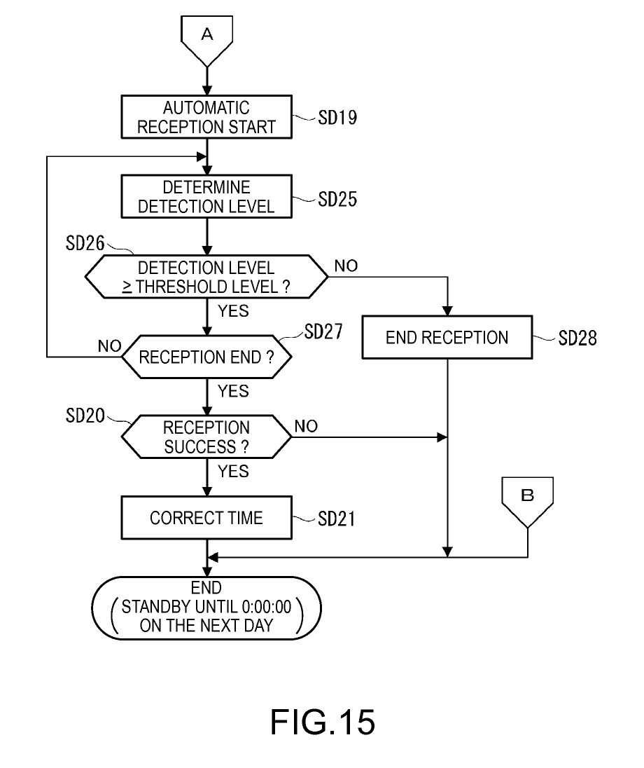

FIGS. 14 and 15 are flow diagrams illustrating operations of a control circuit 40 according to the fourth embodiment.

As shown in FIGS. 14 and 15, the control circuit 40 performs processes of SD11 to SD21 and SD25 to SD28. Here, the processes of SD11 to SD21 are the same processes as SA11 to SA21 in the first embodiment, and thus the description thereof will be omitted.

In the first embodiment, the control circuit 40 starts the reception of a satellite signal in SA19, and then determines that the reception of a satellite signal is made successful in SA20 as it is.

On the other hand, in the fourth embodiment, the control circuit 40 starts the reception of a satellite signal in SD19, and then determines a detection level corresponding to the open voltage on the basis of the detection result RS2 which is output from the power generation state detection circuit 44 (SD25).

Further, the control circuit 40 determines whether the detection level obtained in SD25 is equal to or greater than the threshold level (SD26).

When the determination result of SD26 is YES, the control circuit 40 determines whether the receiving process of a satellite signal is terminated (SD27). When the determination result of SD27 is YES, the process of the control circuit 40 proceeds to SD20. On the other hand, when the determination result of SD27 is NO, the process of the control circuit 40 returns to SD25.

On the other hand, when the determination result of SD26 is NO, the control circuit 40 terminates the receiving process of a satellite signal (SD28), and the process is terminated.

According to the above fourth embodiment, the same operations and effects are obtained by the same processes as those of the first embodiment, and thus the following operations and effects are obtained.

The control circuit 40 determines whether the detection level obtained in SD25 is equal to or greater than the threshold level even during the receiving process of a satellite signal (SD26). When it is determined that the detection level is less than the threshold level (SD26: NO), the control circuit terminates the receiving process (SD28).

According to this, for example, when the electronic timepiece 1 moves indoors from the outdoors during the receiving process and the detection level is less than the threshold level, the control circuit 40 terminates the receiving process. Thereby, it is possible to avoid a state where the receiving process is continuously performed in the environments in which there is no capability of receiving satellite signals, and to suppress a useless receiving process of a satellite signal. Therefore, it is possible to further reduce the power consumption of the electronic timepiece 1.

### Fifth Embodiment

Next, a fifth embodiment of the invention will be described with reference to the accompanying drawings.

Meanwhile, the description of the same content as that of the first embodiment will be omitted.

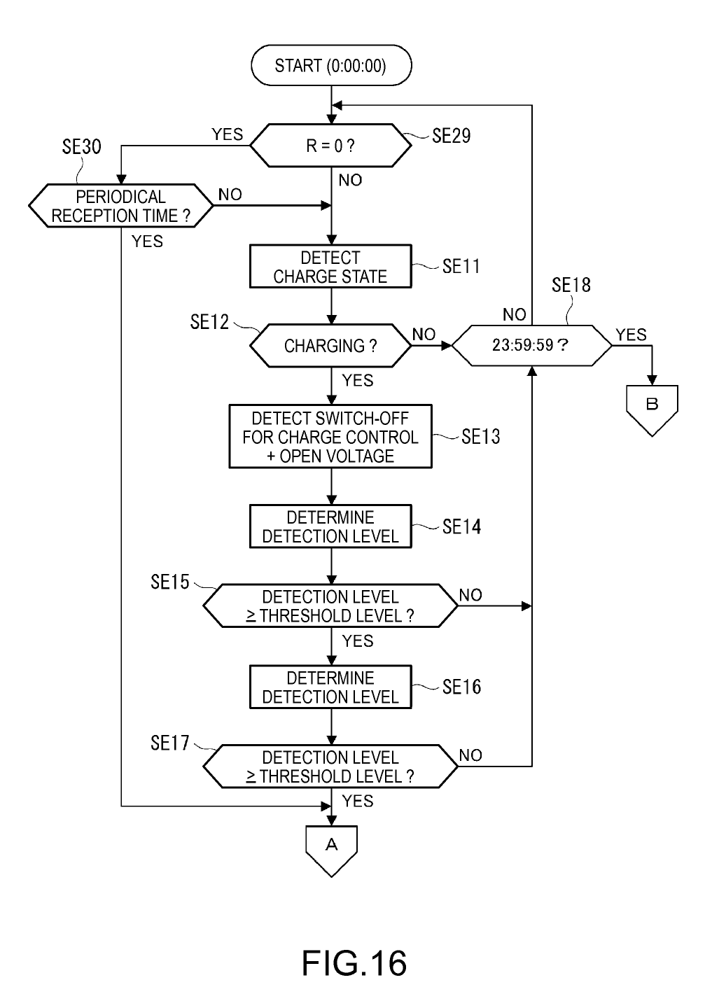

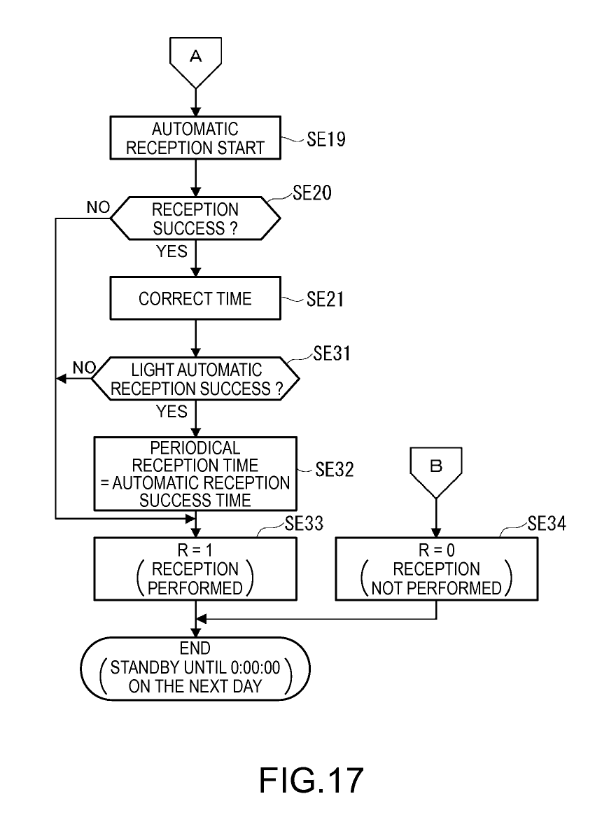

FIGS. 16 and 17 are flow diagrams illustrating operations of a control circuit 40 according to the fifth embodiment.

As shown in FIGS. 16 and 17, the control circuit 40 performs processes of SE11 to SE21 and SE29 to SE34. Here, the processes of SE11 to SE21 are the same processes as SA11 to SA21 in the first embodiment, and thus the description thereof will be omitted.

The control circuit 40 starts control at 0:00:00 everyday. First, the control circuit 40 determines a variable R is “0” (SE29). The variable R is set to “1” in spite of whether the reception is made successful when the receiving process of a satellite signal is performed within 24 hours which are a predetermined time. On the other hand, when the receiving process is never performed within 24 hours, that is, when an indoor arrangement state in which it is determined that the electronic timepiece 1 is disposed indoor continues for 24 hours or more, the variable is set to “0”. Meanwhile, the predetermined time may be set to anytime without being limited to 24 hours, but is normally preferably set to the time of half a day or more such as half a day (12 hours), one day (24 hours), and two days (48 hours).

When the determination result of SE29 is NO (when the variable R is “1”, and the receiving process is performed within the predetermined time), the process of the control circuit 40 proceeds to SE11.

On the other hand, when the determination result of SE29 is YES (when the variable R is “0”, and the receiving process is not performed within the predetermined time), the control circuit 40 determines whether the current time is a preset periodical reception time (SE30). Here, the periodical reception time, described later in details, is a reception start time when light automatic reception succeeds, and is stored by the control circuit 40. Meanwhile, the periodical reception time may be a reception end time. The light automatic reception, as mentioned above, refers to a receiving process performed when the illuminance of light incident on the solar cell 22 is equal to or greater than the illuminance threshold.

In addition, for example, when the periodical reception time is not stored after a system reset, the process of SE30 may be performed while a default time is regarded as the periodical reception time, and it may be determined that periodical reception is not performed without performing periodical reception (the determination result of SE30 is NO).

When the determination result of SE30 is NO, the process of the control circuit 40 proceeds to SE11. On the other hand, when the determination result of SE30 is YES, the process of the control circuit 40 proceeds to SE19.

That is, when the receiving process is not performed within the predetermined time, the control circuit 40 determines whether the light automatic reception can be performed until the current time is set to the periodical reception time. When it is determined that the current time is set to the periodical reception time, the control circuit 40 performs the periodical reception for forcibly performing the receiving process of a satellite signal, regardless of the intensity of the illuminance of light incident on the solar cell 22.

In addition, when it is determined that the reception of a satellite signal is not made successful by the receiving process (SE20: NO), the control circuit 40 sets the variable R to “1” (SE33) to terminate the process, and the flow proceeds to a standby state until 0:00:00 on the next day which is the control restart time.

On the other hand, when it is determined that the reception of a satellite signal is made successful by the receiving process (SE20: YES), the control circuit 40 performs time correction (SE21), and then determines whether this reception is based on the light automatic reception (SE31). After this, when it is determined that the light automatic reception succeeds (SE31: YES), the control circuit 40 deletes the stored periodical reception time, stores the start time (automatic reception success time) of this successful light automatic reception as the periodical reception time (SE32), and performs the process of SE33. On the other hand, when it is determined that the periodical reception succeeds (SE31: NO), the control circuit 40 performs the process of SE33 without performing the process of SE32.

Meanwhile, in the process of SE32, even when the automatic reception success time is “12:00:30”, the control circuit 40 stores “12:00:00” as the periodical reception time. That is, before the automatic reception success time is stored as the periodical reception time, it is determined whether the automatic reception success time is included in any time zone out of a plurality of time zones which are set at 1-minute intervals, and a specific time of this time zone is stored as the automatic reception success time. For example, when the automatic reception success time is included in the time zone from “12:00:00” to “12:00:59”, “12:00:00” obtained by rounding down a second value of this time zone is stored as the periodical reception time.

In addition, when the determination result of SE18 is YES (when a predetermined time elapses), the variable R is set to “0” (SE34), the process is terminated, and the flow proceeds to a standby state until the control restart time when the process in the control circuit 40 is next started.

According to the above fifth embodiment, the same operations and effects are obtained by the same processes as those of the first embodiment, and thus the following operations and effects are obtained.

When it is determined in SE17 that the detection level is equal to or greater than the threshold level, the control circuit 40 determines that the electronic timepiece 1 is disposed outdoors, and receives a satellite signal. On the other hand, when the indoor arrangement state continues for a period of 24 hours or more which is a predetermined time, a satellite signal is received at a preset periodical reception time.

For this reason, a satellite signal is not received in the indoor arrangement state having a high possibility of failure in reception, and thus it is possible to suppress useless power consumption. In addition, even when it cannot be determined that the electronic timepiece 1 is located outdoors due to the electronic timepiece 1 being hidden in a sleeve, in spite of the electronic timepiece 1 being disposed outdoors, a satellite signal is received at a preset periodical reception time when the indoor arrangement state continues for a period of 24 hours or more. Therefore, it is possible to receive a satellite signal at an appropriate timing regardless of the determination result of the arrangement state of the electronic timepiece 1.

In addition, when the light automatic reception or the periodical reception is performed, the control circuit 40 set the variable R to “1”. When the variable R is “1” in the next process, the control circuit 40 performs only the light automatic reception without performing the periodical reception.

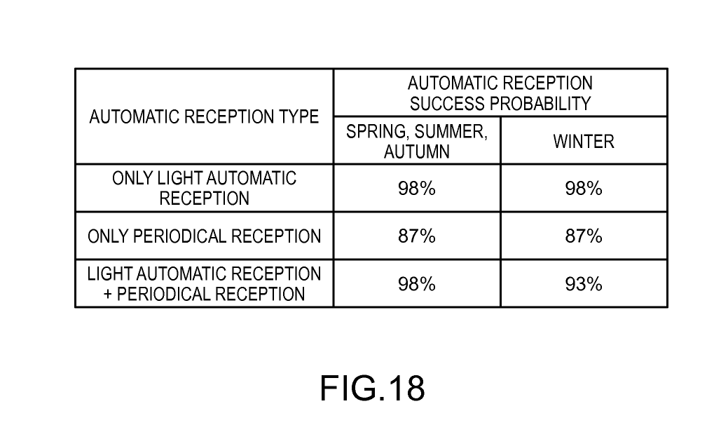

Therefore, since only the light automatic reception having a higher possibility of success than that in the periodical reception is performed, as shown in FIG. 18, on the next day after the receiving process is performed, it is possible to receive a satellite signal without consuming useless power as compared with a case where both the periodical reception and the light automatic reception are performed.

Further, the control circuit 40 sets a success time of the light automatic reception in the past as the periodical reception time.

Therefore, it is possible to set the periodical reception time so as to be adapted to the life pattern of a user, and to improve reception success probability. Particularly, the time at which the light automatic reception succeeds finally is set as the periodical reception time, and thus it is possible to perform reception at a time adapted to the recent lift pattern.

The control circuit 40 does not store the automatic reception success time as the periodical reception time as it is, but stores a specific time of the time zone including the automatic reception success time as the automatic reception success time.

Therefore, a user can easily ascertain the periodical reception time.

### Other Embodiments

Meanwhile, the invention is not limited to the configuration of each of the embodiments, and various modifications can be made without departing from the scope of the invention.

For example, in the second embodiment, the value of a high-illuminance threshold may be set to be within a range of equal to or greater than 1,000 Lx and less than 5,000 Lx. In this case, even when the threshold level is changed to a detection level corresponding to the high-illuminance threshold, it is possible to improve the frequency of receiving satellite signals, and to suppress a useless receiving process of a satellite signal.

In addition, in the embodiment, the illuminance threshold is set to be within a range of equal to or greater than 1,000 Lx and less than 5,000 Lx, but may be set to be within a range of, for example, equal to or greater than 1,000 Lx and less than 3000 Lx in order to improve the frequency of receiving satellite signals. On the contrary, the illuminance threshold may be set to be within a range of, for example, equal to or greater than 3000 Lx and less than 5,000 Lx in order to further suppress the receiving process of a useless satellite signal.

In addition, in the embodiment, the control circuit 40 twice performs the determination of whether the detection level obtained on the basis of the open voltage detected in the power generation state detection circuit 44 is equal to or greater than the threshold level, but may perform the determination once, or three times or more.

In addition, in the embodiment, the automatic receiving process is the time measurement mode, but may be the positioning mode.

In addition, in the embodiment, the solar cell 22 is used, but a photo-resistor, a photo-transistor, a photo-diode and the like may be used instead of the solar cell 22.

In addition, in the embodiment, the periodical receiving process is fixed to the time measurement mode, but may be configured to be capable of selecting the time measurement mode and the positioning mode and performing the periodical receiving process by setting a receiving mode through a user's previous button operation.

In addition, in the embodiment, the GPS satellite has been described as an example of a position information satellite, the position information satellite according to the invention may include not only the GPS satellite, but also other global navigation satellite systems (GNSS) such as Galileo (EU), GLONASS (Russia), and Wain (China), stationary satellites such as SBAS, and position information satellites, such as a quasi-zenith satellite, which send out satellite signals including time information.

The satellite signal receiving device according to the invention and the electronic timepiece having the satellite signal receiving device are not limited to a watch, but can be widely used in, for example, devices, such as a cellular phone and a portable GPS receiver used for mountain climbing or the like, which are driven by a battery or the like and receive satellite signals transmitted from position information satellites.

The entire disclosure of Japanese Patent Application No. 2013-35510, filed Feb. 26, 2013 and of Provisional Application No. 61/770, 577, filed Feb. 28, 2013 is expressly incorporated by reference herein.

What is claimed is:

1. A satellite signal receiving device comprising:
a receiving section that receives a satellite signal transmitted from a position information satellite;
a solar cell that converts light energy into electrical energy; and
a control section that controls the receiving section and starts a receiving process of the satellite signal, when illuminance of light incident on the solar cell is equal to or greater a preset illuminance threshold within a range of equal to or greater than 1,000 Lx and less than 5,000 Lx.

2. The satellite signal receiving device according to claim 1, wherein the control section starts the receiving process when the illuminance of light incident on the solar cell is equal to or greater than the illuminance threshold, and the illuminance of light incident on the solar cell after a lapse of a predetermined time is equal to or greater than the illuminance threshold.

3. The satellite signal receiving device according to claim 1, wherein the control section terminates the receiving process when the illuminance of light incident on the solar cell during the receiving process is less than the illuminance threshold.

4. The satellite signal receiving device according to claim 1, wherein the control section changes the illuminance threshold to a high-illuminance threshold having a higher value in a case of failure in the receiving process, and starts the receiving process when the illuminance of light incident on the solar cell is equal to or greater than the high-illuminance threshold.

5. The satellite signal receiving device according to claim 4, the high-illuminance threshold is set to be within a range of equal to or greater than 1,000 Lx and less than 5,000 Lx.

6. The satellite signal receiving device according to claim 1, further comprising:
a power generation state detection section that detects a power generation state of the solar cell,
wherein the control section determines whether the illuminance of light incident on the solar cell is equal to or greater than the illuminance threshold by comparing a detection value detected in the power generation state detection section with a threshold level determined on the basis of the illuminance threshold and a period of use of the solar cell.

7. An electronic timepiece comprising:
a receiving section that receives a satellite signal transmitted from a position information satellite;
a solar cell that converts light energy into electrical energy;
a control section that controls the receiving section and starts a receiving process of the satellite signal, when illuminance of light incident on the solar cell is equal to or greater a preset illuminance threshold within a range of equal to or greater than 1,000 Lx and less than 5,000 Lx;
a clocking section that clocks a time; and
a time display section that displays the time clocked by the clocking section,
wherein when time information is acquired successfully by the receiving process, the control section corrects the time clocked by the clocking section on the basis of the acquired time information.

8. A satellite signal receiving method comprising:
causing light to be incident on a solar cell; and
starting a receiving process of a satellite signal when illuminance of light incident on the solar cell is equal to or greater a preset illuminance threshold within a range of equal to or greater than 1,000 Lx and less than 5,000 Lx.
